(19) United States
(12) Patent Application Publication
(10) Pub. No.: US 2008/0145117 A1
(43) Pub. Date: Jun. 19, 2008

(54) IMAGE FORMING APPARATUS

(76) Inventors: Toshiki TAKIGUCHI, Nara (JP); Hirokazu Yamauchi, Kyoto (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/956,443

(22) Filed: Dec. 14, 2007

(30) Foreign Application Priority Data
Dec. 18, 2006 (JP) 2006-340171
Jan. 26, 2007 (JP) 2007-015865

(51) Int. Cl. G03G 21/00

(52) U.S. Cl. 399/350

(57) ABSTRACT

In one embodiment of the present invention, an image forming apparatus is presumed that develops an electrostatic latent image on the surface of a photoreceptor, thus forming a visible image on the surface of the photoreceptor, transfers the visible image from the surface of the photoreceptor to recording paper, separates the recording paper from the surface of the photoreceptor with a separation claw, and cleans the surface of the photoreceptor with a cleaning blade. The cleaning blade is in sliding contact with the surface of the photoreceptor, and smoothes damage that has been formed on the surface of the photoreceptor by contact of the separation claw.

### BACKGROUND OF THE INVENTION

This application claims priority under 35 U.S.C. § 119(a) on Japanese Patent No. 2006-340171 filed in Japan on Dec. 18, 2006, and Japanese Patent Application No. 2007-015865 filed in Japan on Jan. 26, 2007, and the entire contents of which are hereby incorporated by reference.

The present invention relates to an image forming apparatus such as a copier, printer, or facsimile machine, and more specifically relates to an image forming apparatus provided with a separation claw that separates recording paper from the surface of a photoreceptor, and a cleaning blade that cleans the surface of the photoreceptor.

Conventionally, in an image forming apparatus, an electrostatic latent image on the surface of a photoreceptor is developed with a developer to form a developer image (visible image) on the surface of the photoreceptor, and this developer image is transferred from the surface of the photoreceptor to recording paper.

Transfer of the developer image is performed in a transfer magnetic field with the recording paper superimposed on the developer image on the surface of the photoreceptor. At this time, the recording paper is charged and electrostatically attracted to the surface of the photoreceptor, so after transferring the developer image, it is necessary to peel away the recording paper from the surface of the photoreceptor.

Various methods have already been proposed for peeling away recording paper from the surface of a photoreceptor, and methods whose effect is promising include a natural separation method in which the diameter of the photoreceptor is reduced, so that a paper leading edge portion is easily separated from a curved face of the outer circumference of the photoreceptor by the stiffness of the paper, and a method in which a separation claw is provided that contacts the surface of the photoreceptor, and the paper leading edge portion is forcibly separated from the surface of the photoreceptor by the separation claw.

The natural separation method is not often used, for reasons such as that the stiffness of the paper leading edge portion differs according to the type of paper (paper thickness, material, or the like), the diameter of the photoreceptor is often determined according to the print processing speed of the apparatus, and the outer circumference of the photoreceptor does not necessarily have a curvature that is appropriate for separating the paper. For example, separation performance is good for thick paper (paper with a basis weight of 128 g/m² or more), and separation performance is poor for thin paper (paper with a basis weight of 80 to 100 g/m² or less). This is due to the stiffness of the paper and the curvature of the photoreceptor.

On the other hand, with a method of forcibly separating the paper with a separation claw, it is possible to obtain a fixed effect regardless of the type of paper or the print processing speed of the apparatus.

However, because the separation claw contacts the surface of the photoreceptor and collides with the leading edge of the paper, while repeatedly separating many sheets of paper, the leading edge of the separation claw is continually chipped, and thus much damage occurs at the leading edge of the separation claw. Because the damaged separation claw contacts the surface of the photoreceptor, the surface of the photoreceptor is damaged. When a developer image on the surface of the photoreceptor has been transferred to recording paper, the damage to the surface of the photoreceptor causes printing defects such as black or white streaks on the recording paper.

In order to eliminate these printing defects, various proposals have been made, such as proposals with respect to the material of the separation claw and methods of mitigating impact force when the separation claw and the photoreceptor collide. For example, in JP H05-249836A, technology is disclosed in which, by moving the separation claw back and forth in a direction along the circumferential face of the photoreceptor and perpendicular to the rotational direction of the photoreceptor, paper separation performance is improved and damage to the photoreceptor is reduced.

However, in JP H05-249836A, the separation claw is always in contact with the surface of the photoreceptor, so deterioration of the separation claw occurs quickly and over a large area, and thus damage to the leading edge of the peeling catch is not reduced or prevented with JP H05-249836A. Also, even if the separation claw is moved back and forth, it is difficult to think that the paper separation performance will improve, and there is a possibility that paper jams will occur more often.

Also, when selecting the material of the separation claw, the diameter of the photoreceptor and the hardness of a surface layer of the photoreceptor are determined according to a sensitivity of the surface layer that is suitable for the print processing speed, so the material of the separation claw must be variously selected according to the diameter of the photoreceptor and the hardness of the surface layer, and thus selection of the material of the separation claw is difficult.

### SUMMARY OF THE INVENTION

The present invention was made in view of the above conventional problems, and it is an object thereof to provide and image forming apparatus capable of reducing damage to the surface of a photoreceptor due to contact with a separation claw.

In order to address the above problems, the present invention provides an image forming apparatus that develops an electrostatic latent image on the surface of a photoreceptor, thus forming a visible image on the surface of the photoreceptor, transfers the visible image from the surface of the photoreceptor to a sheet of recording paper, separates the sheet of recording paper from the surface of the photoreceptor with a separation claw, and cleans the surface of the photoreceptor with a cleaning blade, wherein the cleaning blade is in sliding contact with the surface of the photoreceptor, and smoothes damage that has been formed on the surface of the photoreceptor by contact of the separation claw. That is, damage to the surface of the photoreceptor is smoothed by sliding contact of the cleaning blade, restoring the surface of the photoreceptor. Thus, it is possible to prevent print defects such as black or white streaks on the sheet of recording paper that are caused by damage to the surface of the photoreceptor.

Here, a conventional cleaning blade is provided with a significant amount of elasticity, and the leading edge thereof is pressed against the surface of the photoreceptor. In this state, with rotational movement of the surface of the photoreceptor, the leading edge of the cleaning blade repeatedly elastically deforms and returns to its original shape, thus vibrating, and so remaining toner or paper dust on the surface of the photoreceptor is flicked away by the leading edge of the vibrating cleaning blade. Vibration of the leading edge of the cleaning blade is referred to as a stick-slip phenomenon.

On the other hand, in the present invention, without using the stick-slip phenomenon, by merely allowing sliding contact of the cleaning blade to the surface of the photoreceptor, remaining toner or paper dust on the surface of the photoreceptor is removed, and at the same time, damage to the surface of the photoreceptor is smoothed, restoring the surface of the photoreceptor. Also, there is the advantage that because the cleaning blade is merely in sliding contact with the surface of the photoreceptor, toner does not scatter, so stains due to toner scattering do not occur.

Also, the damage to the surface of the photoreceptor is formed in an uneven shape on the surface of the photoreceptor, and the cleaning blade scrapes away a projecting portion of the damage to the surface of the photoreceptor.

When unevenness is formed on the surface of the photoreceptor, electromagnetic field concentration is remarkable at the tip of the projecting portion, and at this location, black or white streaks or the like easily occur. By scraping away this projecting portion, it is possible to greatly reduce black or white streaks or the like. Also, the amount of a photoconductive layer of the surface of the photoreceptor that is scraped away can be suppressed to a minimum, thus maintaining the properties of the photoconductive layer.

Further, the cleaning blade is made of rubber member.

With such a cleaning blade, it is possible to appropriately scrape the photoconductive layer of the surface of the photoreceptor.

Also, the sliding contact of the cleaning blade to the surface of the photoreceptor is performed continually without interruption.

Thus, it is possible to appropriately scrape the photoconductive layer of the surface of the photoreceptor.

Further, where the resilience coefficient of the cleaning blade is X, the resilience coefficient X is set in a range of 25<X<35.

Also, where the Young's modulus of the cleaning blade is Y, the Young's modulus Y is set to not less than 800 gf/mm².

Further, where the harness of the cleaning blade is Z, the hardness Z is set in a range of 70°<z<80°.

With such settings for the resilience coefficient X, the Young's modulus Y, and the rubber hardness Z of the cleaning blade, it is possible to appropriately scrape the photoconductive layer of the surface of the photoreceptor with the cleaning blade.

Also, the processing speed of the image forming apparatus is not less than 500 mm/sec. At this time, the above settings for the resilience coefficient X, the Young's modulus Y, and the rubber hardness Z become effective.

Further, the photoreceptor is an organic photoreceptor. The surface layer of an organic photoreceptor is made of organic photoconductor material, and is easily damaged. Thus, the present invention is very effective.

Also, by moving the separation claw relative to the surface of the photoreceptor in a direction perpendicular to the movement direction of the surface of the photoreceptor, it is possible to change the position where the separation claw contacts the surface of the photoreceptor, and the position where the separation claw contacts the surface of the photoreceptor is changed according to the number of sheets of print processing performed by the image forming apparatus.

With this configuration, it is possible to prevent deep formation of damage at specific locations of the surface of the photoreceptor before such damage occurs, and the amount of the photoconductive layer scraped away in order to smooth the surface of the photoreceptor can be suppressed to a minimum, thus maintaining the properties of the photoconductive layer.

Further, the separation claw is sequentially moved so as to contact any of a plurality of positions where contact is made with the surface of the photoreceptor, and while the separation claw makes at least one circuit of each of the contact positions, the cleaning blade smoothes damage formed by the separation claw on the surface of the photoreceptor at each of the contact positions.

With this configuration, it is possible to smooth shallowly formed damage in a large area of the surface of the photoreceptor during the one circuit, and the amount of the photoconductive layer scraped away can be suppressed to a minimum, thus maintaining the properties of the photoconductive layer.

### BRIEF DESCRIPTION OF THE DRAWINGS

FIG. 1 is a cross-sectional view that shows an embodiment of an image forming apparatus according to the present invention.

FIG. 2 is a side view that shows an enlarged view of the surroundings of a photosensitive drum in the image forming apparatus in FIG. 1.

FIG. 3 is a plan view that shows a separation unit in the image forming apparatus in FIG. 1.

FIG. 4 shows a stick-slip phenomenon of a conventional cleaning blade.

FIG. 5 shows a state of sliding contact of the cleaning blade in the image forming apparatus in FIG. 1.

FIG. 6 shows an example method of measuring rubber properties of a cleaning blade.

FIG. 7 shows another example method of measuring rubber properties of the cleaning blade in FIG. 6.

FIG. 8 shows measurement of the depth of damage to the surface of a conventional photosensitive drum.

FIG. 9 shows an enlarged view of damage Xa shown in FIG. 8.

FIG. 10 schematically shows an enlarged view of the damage Xa shown in FIG. 8.

FIG. 11 shows measurement of the depth of damage to the surface of the photosensitive drum in the image forming apparatus in FIG. 1.

FIG. 12 shows an enlarged view of damage XA shown in FIG. 11.

FIG. 13 schematically shows an enlarged view of the damage XA shown in FIG. 11.

FIG. 14 is a plan view that shows a separation unit in a second embodiment of the image forming apparatus of the present invention.

FIG. 15 is a side view that shows an enlarged view of an eccentric cam in the separation unit in FIG. 14.

FIG. 16 is a flowchart that shows a processing procedure for modifying a contact position of each separation claw in the separation unit in FIG. 14.

### DESCRIPTION OF THE PREFERRED EMBODIMENTS

Hereinafter, embodiments of the present invention will be described in detail with reference to the accompanying drawings.

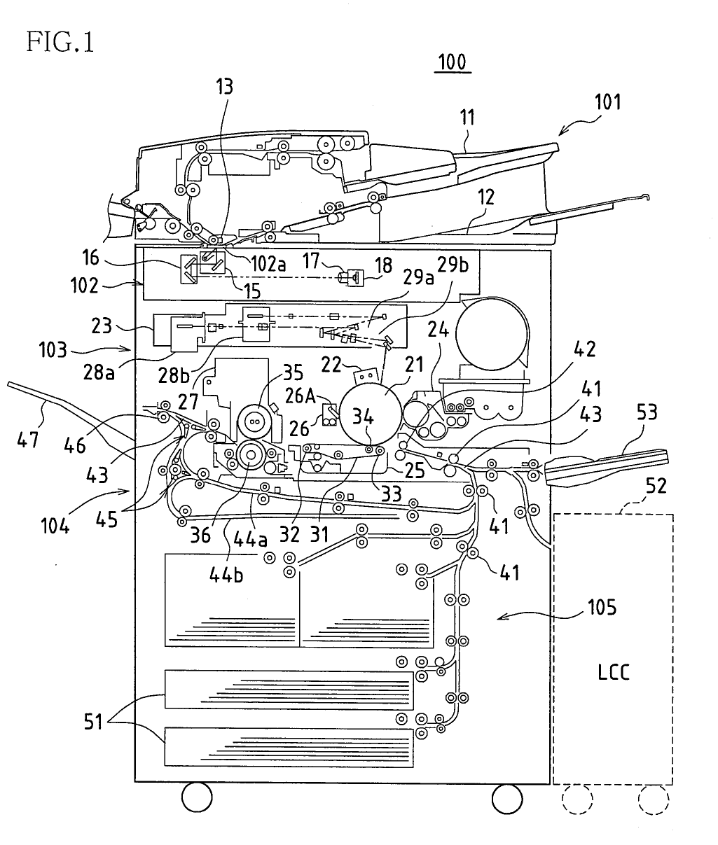

FIG. 1 is a cross-sectional view that shows a first embodiment of an image forming apparatus according to the present invention. An image forming apparatus 100 acquires image data that has been captured from an original paper, or acquires image data received from outside, and forms a monochrome image expressed by this image data onto sheet of recording paper. Broadly speaking, the image forming apparatus is configured with an original paper transport portion (ADF) 101, an image capturing portion 102, a printing portion 103, a sheet of recording paper transport portion 104, and a paper supply portion 105.

In the original paper transport portion 101, when at least one sheet of original paper is set in an original setting tray 11, the original paper is drawn out from the original setting tray 11 sheet by sheet and transported, this original paper is guided to and passed by an original capturing window 102a of the image capturing portion 102, and then the original paper is discharged to a discharge tray 12.

A CIS (Contact Image Sensor) 13 is disposed above the original capturing window 102a. When an original paper passes by the original capturing window 102a, the CIS 13 repeatedly captures an image of the back face of the original paper in a main scanning direction, and outputs image data that expresses the image of the back face of the original paper.

Also, when an original paper passes by the original capturing window 102a, the image capturing portion 102 exposes the original paper surface with a lamp of a first scanning unit 15, guides the reflected light from the original paper surface to an imaging lens 17 with mirrors of the first scanning unit 15 and a second scanning unit 16, and forms the image of the original paper surface on a CCD (Charge Coupled Device) 18 with the imaging lens 17. The CCD 18 repeatedly captures the image of the original paper surface in the main scanning direction, and outputs image data that expresses the image of the original paper surface.

Further, when an original paper has been placed on a glass platen on the upper face of the image capturing portion 102, the first and second scanning units 15 and 16 are moved while maintaining a predetermined speed relationship with each other, the surface of the original paper on the glass platen is exposed by the first scanning unit 15, the reflected light from the original paper surface is guided to the imaging lens 17 with the first scanning unit 15 and the second scanning unit 16, and the image of the original paper surface is formed on the CCD 18 with the imaging lens 17.

With a control circuit of a microcomputer or the like, various image processing is performed on image data that has been output from the CIS 13 or the CCD 18, and then the image data is output to the printing portion 103.

The printing portion 103 records the original expressed by the image data on paper, and is provided with, for example, a photosensitive drum 21, a charging unit 22, an optical writing unit 23, a development unit 24, a transfer unit 25, a cleaning unit 26, and a fixing apparatus 27.

The photosensitive drum 21 is an organic photoreceptor whose surface layer is constituted from organic photoconductive material. The photosensitive drum 21 rotates in one direction, and after the surface of the photosensitive drum 21 is cleaned by the cleaning unit 26, that surface is uniformly charged by the charging unit 22. The charging unit 22 may be a charger-type charging unit, or may be a roller-type or brush-type charging unit that contacts the photosensitive drum 21.

The optical writing unit 23 is a laser scanning unit (LSU) provided with two laser irradiation portions 28a and 28b, and two mirror groups 29a and 29b. With the optical writing unit 23, the image data is input, a laser beam corresponding to the image data is emitted from each of the laser irradiation portions 28a and 28b, these laser beams are irradiated to the photosensitive drum 21 via the mirror groups 29a and 29b, and the uniformly charged surface of the photosensitive drum 21 is exposed to the light, thus forming an electrostatic latent image on the surface of the photosensitive drum 21.

In the optical writing unit 23, a two-beam system is adopted in which the two laser irradiation portions 28a and 28b are provided for compatibility with high speed print processing, thus lightening the load that accompanies acceleration of the irradiation timing.

Instead of a laser scanning unit, it is also possible to use an EL write head or LED write head in which light-emitting elements are aligned in an array as the optical write unit 23.

The development unit 24 forms a toner image (also referred to as a visible image) on the surface of the photosensitive drum 21 by supplying toner to the surface of the photosensitive drum 21 and developing the electrostatic latent image. The transfer unit 25 transfers the toner image on the surface of the photosensitive drum 21 to a sheet of recording paper that has been transported by the paper transport portion 104. The fixing apparatus 27 applies heat and pressure to the sheet of recording paper to fix the toner image on the sheet of recording paper. Afterward, the sheet of recording paper is further transported to a discharge tray 47 by the paper transport portion 104 and thus discharged. Also, the cleaning unit 26 removes and recovers toner remaining on the surface of the photosensitive drum 21 after development and transfer.

Here, the transfer unit 25 is provided with a transfer belt 31, a drive roller 32, an idler roller 33, an elastic electrically conductive roller 34, and the like, and rotates the transfer belt 31 in a state stretched across the rollers 32 to 34 and other rollers. The transfer belt 31 has a predetermined resistance value (for example, 1×10⁹ to 1×10¹³ Ω/cm), and transports the sheet of recording paper that has been placed on the surface of the transfer belt 31. The elastic electrically conductive roller 34 is pressed against the surface of the photosensitive drum 21 via the transfer belt 31, and thus presses the sheet of recording paper on the transfer belt 31 against the surface of the photosensitive drum 21. An electrical field with an opposite polarity to the electrical charge of the toner image on the surface of the photosensitive drum 21 is applied to the elastic electrically conductive roller 34, and the toner image on the surface of the photosensitive drum 21 is transferred to the sheet of recording paper on the transfer belt 31 by the electrical field of opposite polarity. For example, when the toner image has an electrical charge with (−) polarity, an electrical field with (+) polarity is applied to the elastic electrically conductive roller 34.

The cleaning unit 26 presses a cleaning blade 26A against the surface of the photosensitive drum 21, thus removing remaining toner or paper dust from the surface of the photosensitive drum 21. Not all of the toner image on the surface of the photosensitive drum 21 is transferred onto the sheet of recording paper; ordinarily, transfer efficiency is about 85 to 95%, and differs depending on the transfer mechanism. On the other hand, when the sheet of recording paper receives a transfer magnetic field, suspended matter (such as short-fiber cellulose, filler, or bleach) on the surface of the sheet of recording paper is charged to a polarity opposite to that of the transfer magnetic field, and the charged suspended matter is attracted to the surface of the photosensitive drum 21, and becomes affixed matter referred to as paper dust.

Print quality will decrease if remaining toner or paper dust on the surface of the photosensitive drum 21 is not removed. Therefore, it is necessary to clean the surface of the photosensitive drum 21 with the cleaning unit 26.

The fixing apparatus 27 is provided with a hot roller 35 and a pressure roller 36. An unshown pressure member is disposed at both ends of the pressure roller 36 such that the pressure roller 36 is pressed against the hot roller 35 with a predetermined pressure. When a sheet of recording paper is transported to a pressure area (referred to as a nip area) between the hot roller 35 and the pressure roller 36, while the sheet of recording paper is transported by the rollers 35 and 36, the unfixed toner image on the sheet of recording paper is hot melted, and pressure is applied, thus fixing the toner image on the sheet of recording paper.

The paper transport portion 104 is provided with, for example, a plurality of pairs of transport rollers 41 for transporting a sheet of recording paper, a pair of registration rollers 42, a transport path 43, reverse transport paths 44a and 44b, a plurality of branch catches 45, and a pair of discharge rollers 46.

In the transport path 43, a sheet of recording paper is received from the paper feed portion 105 and transported until the leading edge of the sheet of recording paper reaches the registration rollers 42. Because at this time the registration rollers 42 have been temporarily stopped, the leading end of the sheet of recording paper reaches and contacts the registration rollers 42, and so the paper bows. Due to the elastic force of the bowed recording paper, the leading end of the sheet of recording paper is aligned parallel to the registration rollers 42. Afterward, rotation of the registration rollers 42 is started, the sheet of recording paper is transported to the transfer unit 25 of the printing portion 103 by the registration rollers 42, and the sheet of recording paper is further transported to the discharge tray 47 by the discharge rollers 46.

Stoppage and rotation of the registration rollers 42 is performed by on/off switching of a clutch between the registration rollers 42 and a drive shaft, and on/off switching of a motor serving as a drive source of the registration rollers 42.

Also, when recording an image also to the back face of a sheet of sheet of recording paper, the branch catches 45 are selectively switched, the sheet of recording paper is guided from the transport path 43 into the reverse transport path 44b, transport of the sheet of recording paper is temporarily stopped, again the branch catches 45 are selectively switched, and the sheet of recording paper is guided from the reverse transport path 44b into the reverse transport path 44a, thus reversing the front and back of the sheet of recording paper, and then the sheet of recording paper is returned to the registration rollers 42 of the transport path 43 via the reverse transport path 44a.

This sort of transport of recording paper is referred to as switchback transport, and with switchback transport, it is possible to reverse the front and back of the sheet of recording paper, and at the same time switch the leading end and the trailing end of the sheet of recording paper. Accordingly, when the sheet of recording paper is reversed and then caused to return, the trailing end of the sheet of recording paper contacts the registration rollers 42, the trailing end of the sheet of recording paper is aligned parallel to the registration rollers 42, the sheet of recording paper is transported to the transfer unit 25 of the printing portion 103 by the registration rollers 42 beginning with the trailing end of the sheet of recording paper, printing is performed on the back face of the sheet of recording paper, the unfixed toner image on the back face of the sheet of recording paper is hot melted and pressure is applied by the nip area between the rollers 35 and 36 of the fixing unit 27, thus fixing the toner image on the back face of the sheet of recording paper, and afterward the sheet of recording paper is transported to the discharge tray 47 by the discharge rollers 46.

In the transport path 43 and the reverse transport paths 44a and 44b, sensors that detect the position of the sheet of recording paper or the like are disposed at various locations, and based on the position of the sheet of recording paper detected by the sensors, driving of the transport rollers and the registration rollers is controlled, and transport and positioning of the sheet of recording paper are performed.

The paper feed portion 105 is provided with a plurality of paper feed trays 51. Recording paper is accumulated in the paper feed trays 51, and they are provided toward the bottom of the image forming apparatus 100. Also, the paper feed trays 51 are provided with a pickup roller or the like for drawing out recording paper sheet by sheet, and feed the drawn out recording paper to the transport path 43 of the paper transport portion 104.

Because an object of the image forming apparatus 100 is high speed print processing, a capacity capable of storing 500 to 1500 sheets of recording paper of a determinate size is insured for each paper feed tray 51.

Also, provided in a side face of the image forming apparatus 100 is a large capacity cassette (LCC) 52 capable of storing a large quantity of a plurality of types of recording paper, and a manual feed tray 53 for supplying mainly recording paper of an indeterminate size.

The discharge tray 47 is disposed in the side face of the side opposite to the manual feed tray 53. In this configuration it is also possible to dispose a sheet of recording paper post-processing apparatus (that performs stapling, punch processing, or the like) or a plurality of levels of discharge trays as options instead of the discharge tray 47.

In this sort of image forming apparatus 100, print processing speed is accelerated and thus usability is improved. For example, when using A4-standard recording paper, the recording paper transport speed is set to 120 sheets/minute (process speed 600 mm/sec).

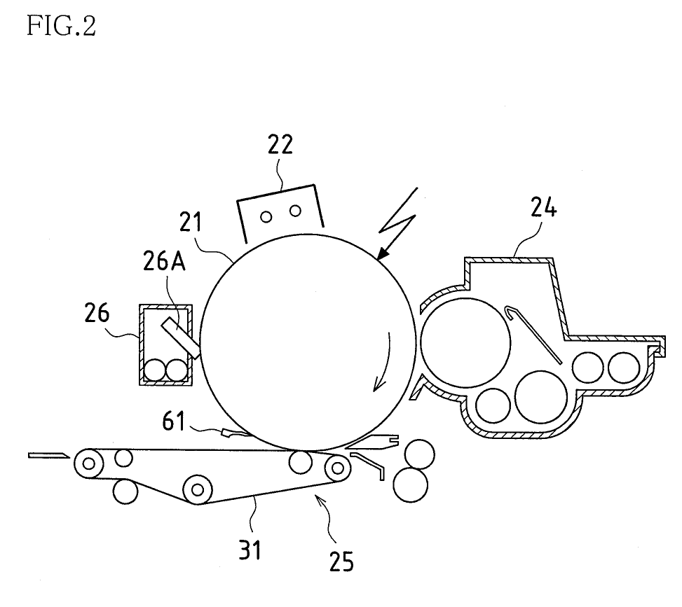

Incidentally, as shown in the enlarged view in FIG. 2, the charging unit 22, the development unit 24, the transfer unit 25, and the cleaning unit 26 are disposed lined up in order in the direction of rotation of the photosensitive drum 21, and furthermore a separation claw 61 is disposed between the transfer unit 25 and the cleaning unit 26.

The transfer unit 25 produces a transfer magnetic field. In this transfer magnetic field, recording paper is overlaid on the toner image on the surface of the photosensitive drum 21, and thus the toner image is transferred from the surface of the photosensitive drum 21 to the recording paper. At this time, the recording paper is charged and electrostatically attracted to the surface of the photosensitive drum 21, so after transfer, it is necessary to peel away the recording paper from the surface of the photosensitive drum 21, and therefore the separation claw 61 is provided.

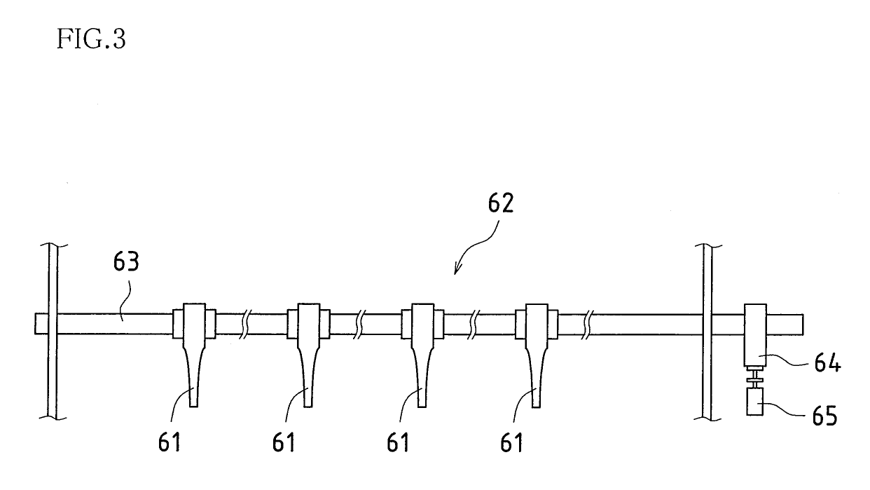

FIG. 3 is a plan view that shows a separation unit 62 having a plurality of separation claws 61. As shown in FIG. 3, in the separation unit 62, a support shaft 63 parallel to the photosensitive drum 21 is rotatably supported, and the plurality of separation claws 61 are supported by the support shaft 63 with gaps between the separation claws 61. Also, a swinging piece 64 is fixed to one end of the support shaft 63, and is linked to a plunger of a solenoid 65.

The leading edge of each separation claw 61 faces the surface of the photosensitive drum 21, and contacts the surface of the photosensitive drum 21 or is slightly separated from that surface according to the position of the plunger of the solenoid 65.

Ordinarily, the leading edge of each separation claw 61 is separated from the surface of the photosensitive drum 21, and when the leading edge portion of the recording paper passes by the transfer unit 25, the leading edge of each separation claw 61 contacts the surface of the photosensitive drum 21, peeling away the leading edge portion of the recording paper, and when the leading edge portion of the recording paper has been sufficiently peeled away, the leading edge of each separation claw 61 is slightly separated from the surface of the photosensitive drum 21.

Accordingly, whenever a sheet of recording paper passes by the transfer unit 25, each separation claw 61 contacts the surface of the photosensitive drum 21 and peels away the leading edge portion of the recording paper.

Because the separation claws 61 give off heat due to sliding contact with the surface of the photosensitive drum 21, they are preferably made from a material with excellent heat resistance, and in order to release a static charge of the recording paper, they are preferably made from a material having conductivity. For example, preferable materials are POM (polyacetal resin), polyimide, Duracon (registered trademark), and the like.

However, whenever recording paper is peeled away from the surface of the photosensitive drum 21 by a separation claw 61, the separation claw 61 contacts the surface of the photosensitive drum 21 and collides with the leading edge of the recording paper, so while repeatedly separating many sheets of recording paper, the leading edge of the separation claw 61 is continually chipped, and thus much damage occurs at the leading edge of the separation claw 61. Because the leading edge of the separation claw 61 contacts the surface of the photosensitive drum 21, damage to the leading edge of the separation claw 61 damages the surface of the photosensitive drum 21, and damage to the surface of the photosensitive drum 21 causes printing defects such as black or white streaks on the recording paper.

When the photosensitive drum 21 is an organic photoreceptor, its surface layer is easily damaged, and damage to the surface of the photosensitive drum 21 caused by damage to the leading edge of a separation claw 61 definitely occurs.

Also, when the surface of the photosensitive drum 21 receives a history due to increased temperature within the image forming apparatus, and friction with the members disposed around the photosensitive drum 21 such as the development unit 24, the cleaning blade 26A, the charging unit 22, and the like, a filming phenomenon occurs in which remaining toner affixed to the surface of the photosensitive drum 21 softens and becomes film-like, and this leads to a reduction in print quality.

Consequently, in the present embodiment, attention is focused on the cleaning blade 26A of the cleaning unit 26 pressed against the surface of the photosensitive drum 21. Using the cleaning blade 26A, damage to the surface of the photosensitive drum 21 is smoothed, and toner filming is removed.

The inventor(s) discovered that if a resilience coefficient, rubber hardness, and Young's modulus of the cleaning blade 26A are appropriately set, it is possible to eliminate toner filming on the surface of the photosensitive drum 21 with the cleaning blade 26A at the same time as smoothing damage to the surface of the photosensitive drum 21.

Because the surface layer of the photosensitive drum 21 is scraped at the same time as removing the filming toner, it is necessary to perform scraping to a degree that the sensitivity of the photosensitive drum 21 is not reduced, and the life of the photosensitive drum 21 is not shortened.

The sensitivity of the photosensitive drum 21 is reduced when about 20 to 30% of the thickness of the surface layer (20 to 30 μm) of the photosensitive drum 21 is scraped. Therefore, when the maximum amount of scraping of the surface layer of the photosensitive drum 21 is about 4 to 9 μm, and the life of the photosensitive drum 21 is 1,000,000 sheets printed (A4 landscape transport), the scraping amount should be 0.4 to 0.9 μm for every 1,000,000 sheets, and it is necessary to select a material for the cleaning blade 26A, and necessary to set a pressure that the cleaning blade 26A applies to the surface of the photosensitive drum 21, that conforms with this scraping amount.

For example, if the hardness of the cleaning blade 26A is set higher than the hardness of a conventional cleaning blade, appropriate scraping of the surface layer of the photosensitive drum 21 (including filming toner) with the cleaning blade 26A is possible.

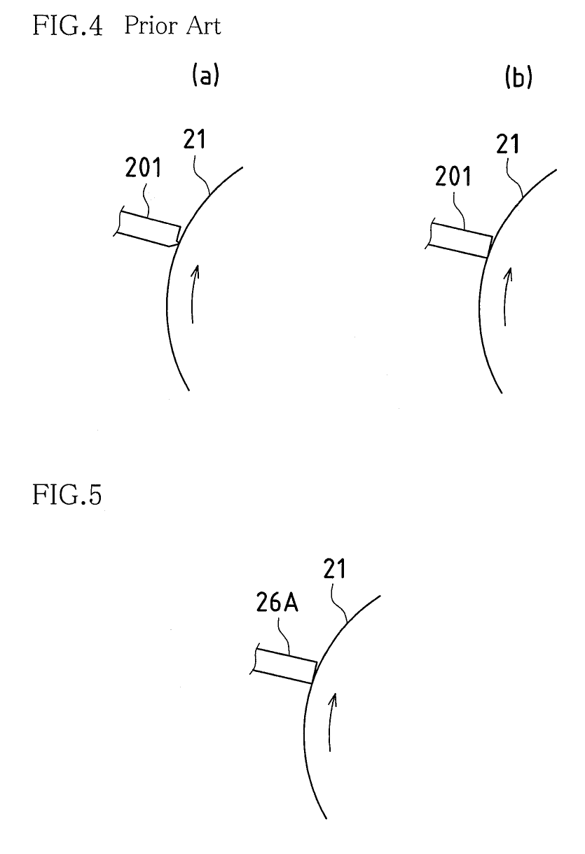

A conventional cleaning blade is provided with a significant amount of elasticity, and the leading edge thereof is pressed against the surface of a photosensitive drum. Therefore, as shown in FIG. 4, with rotational movement of the photosensitive drum 21, the leading edge of a conventional cleaning blade 201 repeatedly elastically deforms and returns to its original shape, thus vibrating, and so remaining toner or paper dust on the surface of the photosensitive drum 21 is flicked away by the leading edge of the vibrating cleaning blade 201. Vibration of the leading edge of the cleaning blade 201 is referred to as a stick-slip phenomenon.

In the present embodiment, such a stick-slip phenomenon is not relied upon; this phenomenon is eliminated. After appropriately setting the resilience coefficient, rubber hardness, and Young's modulus of the cleaning blade 26A by selecting the material of the cleaning blade 26A, when the pressure applied to the surface of the photosensitive drum 21 by the cleaning blade 26A is appropriately set, the stick-slip phenomenon does not occur. As shown in FIG. 5, the cleaning blade 26A is approximately always in sliding contact with the surface of the photosensitive drum 21, the cleaning blade 26A appropriately scrapes the surface layer of the photosensitive drum 21 (including filming toner), and thus damage to the surface of the photosensitive drum 21 is smoothed, restoring the surface of the photosensitive drum 21. At the same time, it is possible to remove remaining toner or paper dust on the surface of the photosensitive drum 21, with the cleaning blade 26A. Also, because the cleaning blade 26A is merely in sliding contact with the surface of the photosensitive drum 21, toner does not scatter, so stains due to toner scattering do not occur.

Next is a description of the results of testing that was performed with respect to the resilience coefficient, rubber hardness, and Young's modulus of the cleaning blade.

Prior to testing, a measurement was performed in advance to confirm that the depth of damage to the surface of the photosensitive drum 21 (height of unevenness formed as damage), caused by damage to the leading edge of a separation claw 61, was 1 to 3 μm.

Also, the cleaning blade was pressed against the surface of the photosensitive drum 21 with a predetermined pressure, and the surface layer was appropriately scraped, thus smoothing the damage to the surface of the photosensitive drum 21 with the cleaning blade.

Further, the photosensitive drum 21 was an organic photoreceptor. Also, the conventional cleaning blade 201 and two types of cleaning blades as the cleaning blade 26A according to the present embodiment (one indicated by reference numeral 26A1, and the other indicated by reference numeral 26A2) were used. The resilience coefficient, rubber hardness, and Young's modulus of these cleaning blades were as shown in following Table 1.

TABLE 1

| | Rubber Properties of Blade | | |
|---|---|---|---|
| Blade | Resilience | Rubber | |
| Reference | Coefficient | Hardness | Young's Modulus |
| Numeral | (%) | (degree) | (gf/mm²) |
| 201 | 45 | 70 | 625 |
| 26A1 | 26 | 79 | 1005 |
| 26A2 | 34 | 74 | 830 |

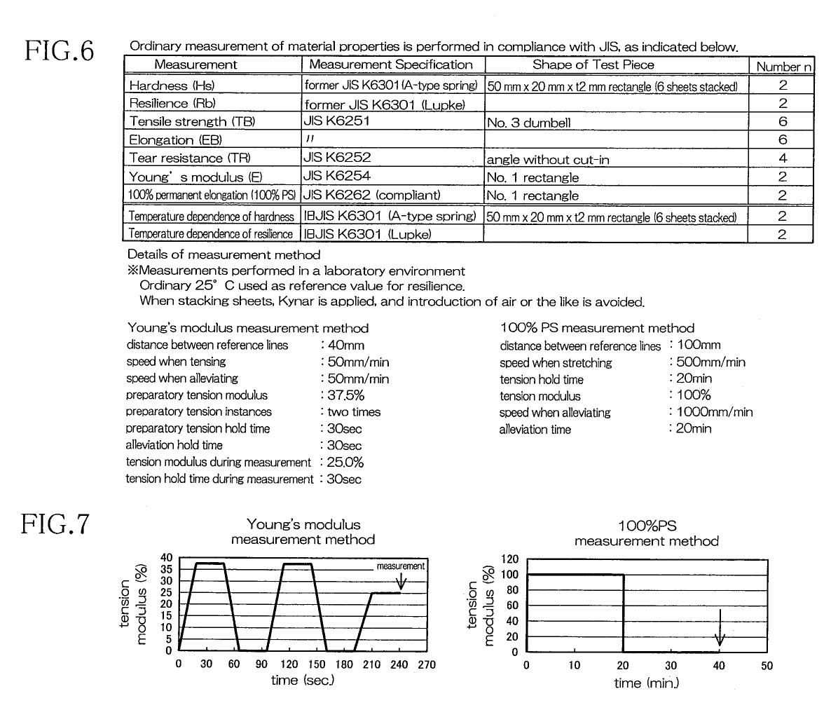

The measurement devices used to measure the rubber properties of the cleaning blades are as indicated below. Also, measurement methods based on Japanese Industrial Standard specifications as shown for example in FIGS. 6 and 7 were adopted.

Resilience: Lupke resilience tester made by Ueshima Seisakusho Co., Ltd.

Hardness: TYPE-A measurement device made by Tecock Young's modulus: autograph tester made by Shimadzu Corp.

In this testing, the diameter of the photosensitive drum 21 was 120 mm, and the cleaning blade contact pressure on the surface of the photosensitive drum 21 was 1.25 N.

Under conditions of setting processing speed to 350 mm/sec (intermediate-speed device) and using the conventional cleaning blade 201, print processing was continually performed, and at each of a predetermined number of printed sheets (10,000 sheets), a determination was made of printing defects, staining of the surface of the photosensitive drum 21, and the scraping state of the surface layer of the photosensitive drum 21, and an overall determination was made. Also, under the three conditions of setting processing speed to 600 mm/sec (high-speed device), using the conventional cleaning blade 201, and using each of the two types of cleaning blades 26A1 and 26A2 of the present embodiment, the same determinations were made.

The determination of print defects was a visual determination of black or white streaks or the like on the recording paper caused by damage to the leading edge of the separation claw 61. The determination of staining of the surface of the photosensitive drum 21 was a visual determination of the extent of staining. The determination of the scraping state of the surface layer of the photosensitive drum 21 was based on the measured scraping amount, and was determined to be better when there was less scraping. The results of such determinations was as shown in following Table 2.

TABLE 2

| | Printing | | | | |
|---|---|---|---|---|---|
| | Defects Due | | | | |
| | To | | Scraping | | |
| Blade | Separation | | Surface | | |
| Reference | claw | Cleaning | Layer of | | |
| Numeral | Damage | Properties | Photoreceptor | Overall | Comments |
| 201 | average | good | good | good | Circumferential Velocity of |
| | | | | | Photoreceptor: 350 mm/sec |
| 201 | very poor | very poor | very good | poor | Circumferential Velocity of |
| | | | | | Photoreceptor: 600 mm/sec |
| 26A1 | good | avg-good | avg-good | good | Circumferential Velocity of |
| | | | | | Photoreceptor: 600 mm/sec |
| 26A2 | very good | good | good | very | Circumferential Velocity of |
| | | | | good | Photoreceptor: 600 mm/sec |

As is clear from Table 2 above, under conditions of setting processing speed to 350 mm/sec (intermediate-speed device) and using the conventional cleaning blade 201, processing speed was low, so even in the case of the conventional cleaning blade 201, printing errors were not noticeable, the extent of staining of the surface of the photosensitive drum 21 was low, and the state of scraping of the surface layer of the photosensitive drum 21 was good.

However, under conditions of setting processing speed to 600 mm/sec (high-speed device) and using the conventional cleaning blade 201, printing errors were noticeable, and the extent of staining of the surface of the photosensitive drum 21 was high. This is thought to be due to the fact that because processing speed was high, the rubber hardness of the conventional cleaning blade 201 was insufficient, chipping of the leading edge of the blade occurred due to reversal (twisting) of the leading edge of the blade or frictional heat between the leading edge of the blade and the surface of the photosensitive drum 21.

Consequently, the two types of cleaning blades 26A1 and 26A2 were applied, having lower resilience coefficients, greater rubber hardness, and higher Young's moduli than the conventional cleaning blade 201.

With the cleaning blade 26A1, there were almost no printing defects, the extent of staining of the surface of the photosensitive drum 21 was generally small, and the state of scraping of the surface layer of the photosensitive drum 21 also was generally good.

With the cleaning blade 26A2, there were almost no printing defects, the extent of staining of the surface of the photosensitive drum 21 was generally small, and the state of scraping of the surface layer of the photosensitive drum 21 also was generally good.

With respect to print defects such as black or white streaks on the recording paper caused by damage to the leading edge of the separation claw 61, the blade 26A2 was best, next was the blade 26A1, and the poorest was the conventional blade 201.

Also, with respect to staining of the photosensitive drum 21, the blade 26A2 was best, next was the blade 26A1, and the poorest was the conventional blade 201.

Furthermore, with respect to scraping of the surface layer of the photosensitive drum 21, the conventional blade 201 was best (had the least amount of scraping), next was the blade 26A2, followed by the blade 26A1. More specifically, the scraping amount for the conventional blade 201, which had the least scraping, was 0.4 μm (per 10,000 sheets), and the scraping amount for the blade 26A1, which had the most scraping, was 0.8 to 1.0 μm (per 10,000 sheets).

However, as stated previously, the scraping amount per 100,000 sheets needs to be set to 0.4 to 0.9 μm, and the scraping amount with the conventional blade 201 is the minimum value 0.4 μm.

By comparing such results for the scraping state and the blade properties from above Table 1, it became clear that the scraping state of the surface layer of the photosensitive drum 21 depends greatly on the rubber hardness.

Accordingly, when making an overall evaluation of printing defects (damage to the leading edge of the separation claw 61), staining of the surface of the photosensitive drum 21, and the scraping state of the surface layer of the photosensitive drum 21, supposing a high-speed device, the blade 26A2 was best, next was the blade 26A1, and poorest was the conventional blade 201.

Also, from a comparison of the overall evaluation and the blade properties in above Table 1, it became clear that in order to obtain a good overall result where the resilience coefficient is X, the resilience coefficient is preferably set in a range of 25<X<35, and where the Young's modulus of the cleaning blade is Y, the Young's modulus Y is preferably set to not less than 800 gf/mm², and where the hardness of the cleaning blade is Z, the hardness Z is preferably set in a range of 70°<Z<80°.

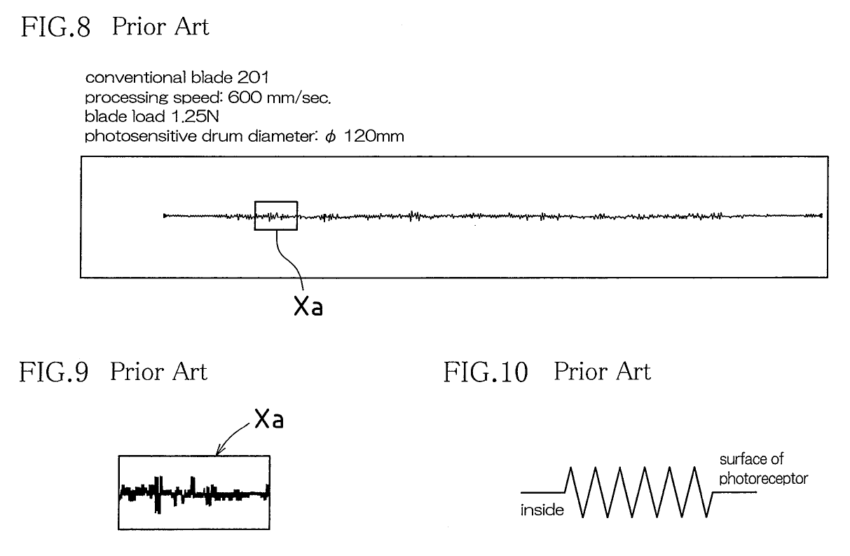

On the other hand, FIG. 8 shows measurement of the depth of damage to the surface of the photosensitive drum 21 when the conventional cleaning blade 201 was used.

As shown in FIG. 8, the damage becomes deep at each location of the surface of the photosensitive drum 21 that contacts the respective separation claws 61. FIG. 9 shows an enlarged view of damage Xa at locations of the surface of the photosensitive drum 21 that contact a separation claw 61 in FIG. 8, and FIG. 10 schematically shows an enlarged view of the damage Xa shown in FIG. 9.

When the conventional cleaning blade 201 was used, the scraping amount of the surface layer of the photosensitive drum 21 was too small, so as shown in FIG. 10, damage to the surface of the photosensitive drum 21 remained as-is in an uneven manner. Electromagnetic field concentration is remarkable at a projecting portion of this uneven shape, such that surface electric potential of the projecting portion is unusually high, and a discharge phenomenon occurs, which leads to a reduction in the surface potential at this location, so toner affixes excessively at this location. Thus, black or white streaks easily occur.

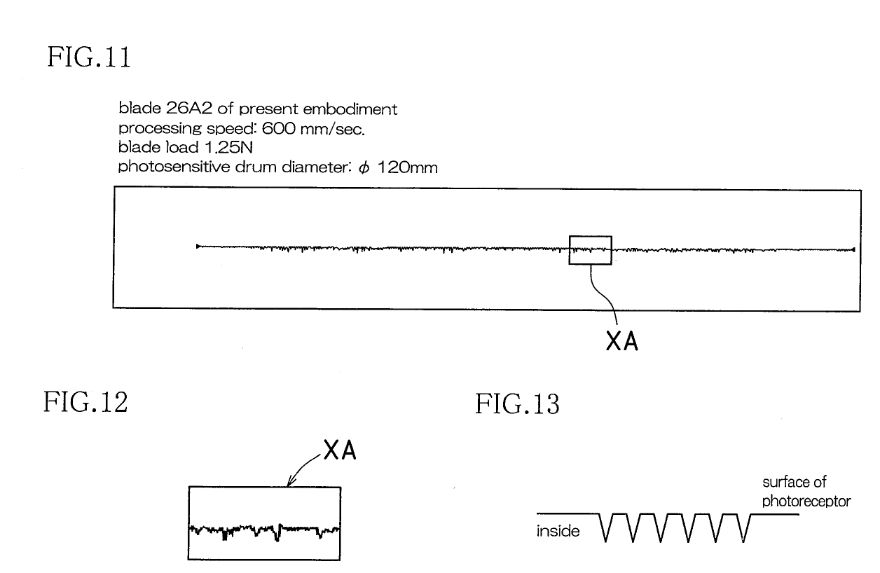

FIG. 11 shows measurement of the depth of damage to the surface of the photosensitive drum 21 when the cleaning blade 26A2 according to the present embodiment was used. As shown in FIG. 11, the damage becomes slightly deeper at each location of the surface of the photosensitive drum 21 that contacts the respective separation clawes 61. FIG. 12 shows an enlarged view of damage XA at locations of the surface of the photosensitive drum 21 that contact a separation claw 61 in FIG. 11, and FIG. 13 schematically shows an enlarged view of the damage XA shown in FIG. 12.

As shown in FIG. 13, damage to the surface of the photosensitive drum 21 is formed such that projecting portions of the uneven shape in FIG. 10 have been scraped away. This is because the projecting portions of the uneven shape have been scraped away by the cleaning blade 26A2. Accordingly, there are none of the projecting portions where electric field concentration easily occurs, and therefore black or white streaks do not occur.

As is clear from such testing, if the resilience coefficient, Young's modulus, and rubber hardness of the cleaning blade are appropriately set, it is possible to smooth and approximately eliminate damage to the surface of the photosensitive drum 21 and at the same time it is possible to eliminate toner filming on the surface of the photosensitive drum 21. Thus, it is possible to insure the cleaning properties of a high speed device, and possible to insure print quality.

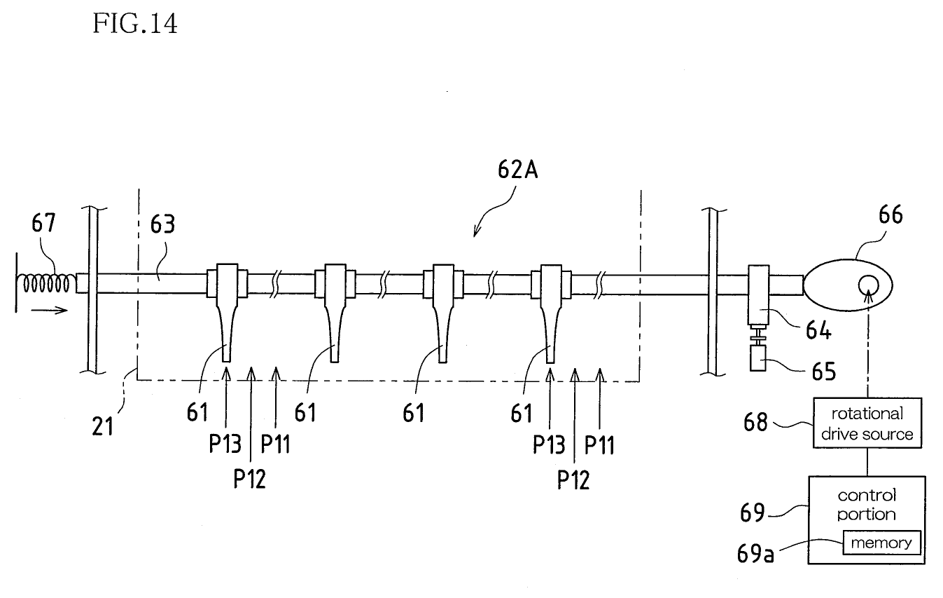

FIG. 14 is a plan view that shows a separation unit 62A in a second embodiment of the image forming apparatus of the present invention. In FIG. 14, the same reference numerals are used for components that fulfill the same functions as in FIG. 3.

The image forming apparatus of the present embodiment has approximately the same configuration as the image forming apparatus 100 in FIG. 1, and differs in that a separation unit 62A is disposed instead of the separation unit 62 at the periphery of the photosensitive drum 21.

This separation unit 62A, same as the separation unit 62 in FIG. 3, has a plurality of separation claws 61, a support shaft 63, a swinging piece 64, and a solenoid 65. The separation unit 62A is furthermore provided with an eccentric cam 66 that contacts the right end (right end in FIG. 14) of the support shaft 63, a spring 67 that presses against the left end (left end in FIG. 14) of the support shaft 63 and biases the support shaft 63 in the rightward direction, a rotational drive source 68 that rotationally drives the eccentric cam 66, and a control portion 69 that controls driving of the rotational drive source 68.

The support shaft 63 is rotationally supported, and also is supported so as to be capable of sliding in the lengthwise direction (axial direction of the photosensitive drum 21) of the support shaft 63. The support shaft 63 is biased in the rightward direction by the spring 67, and the right end of the support shaft 63 is in contact with the circumferential face of the eccentric cam 66. When the eccentric cam 66 is rotated by the rotational drive source 68, changing the position of the circumferential face of the eccentric cam 66 that contacts the right end of the support shaft 63, the support shaft 63 moves in the lengthwise direction of the support shaft 63, this is accompanied by the position of the separation claws 61 that have been fixed to the support shaft 63 also moving in the lengthwise direction, and thus the position where each separation claw 61 contacts the surface of the photosensitive drum 21 is changed.

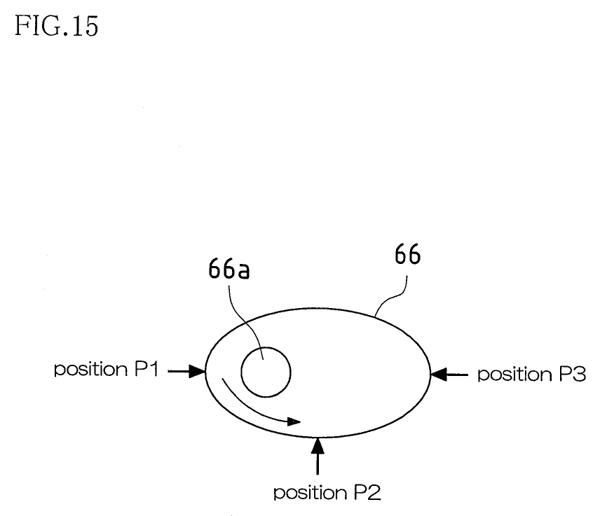

As shown in FIG. 15, in the eccentric cam 66, any of three circumferential face positions P1, P2, and P3 contacts the right end of the support shaft 63. The circumferential face position P1 is closest to a shaft 66a of the eccentric cam 66, the circumferential face position P2 is somewhat separated from the shaft 66a of the eccentric cam 66, and the circumferential face position P3 is most separated from the shaft 66a of the eccentric cam 66. Thus, in a state in which the right end of the support shaft 63 has made contact with the circumferential face position P1 of the eccentric cam 66, the support shaft 63 is positioned at the furthest rightward position, and in a state in which the right end of the support shaft 63 has made contact with the circumferential face position P2 of the eccentric cam 66, the support shaft 63 is positioned at a position slightly to the left, and in a state in which the right end of the support shaft 63 has made contact with the circumferential face position P3 of the eccentric cam 66, the support shaft 63 is positioned at the furthest leftward position. Along with this movement of the support shaft 63, each separation claw 61 also is moved to each of a furthest rightward position P11, a slightly leftward position P12, and a furthest leftward position P13 as shown in FIG. 14, and thus the position where each separation claw 61 contacts the surface of the photosensitive drum 21 is changed.

Thus, it is possible to prevent deep formation of damage at specific locations of the surface of the photosensitive drum 21 before such damage occurs, and the amount of a photoconductive layer scraped away in order to smooth the surface of the photosensitive drum 21 can be suppressed to a minimum, thus maintaining the properties of the photoconductive layer.

In the present embodiment, driving of the rotational drive source 68 is controlled by the control portion 69, rotationally driving the eccentric cam 66 with the rotational drive source 68 to change the position where each separation claw 61 contacts the surface of the photosensitive drum 21. The control portion 69 changes the position where each separation claw 61 contacts the surface of the photosensitive drum 21 according to the number of sheets of print processing performed by the image forming apparatus. Also, the control portion 69 not only controls the rotational drive source 68, but also fulfills the role of performing overall control of the image forming apparatus 100 as a whole.

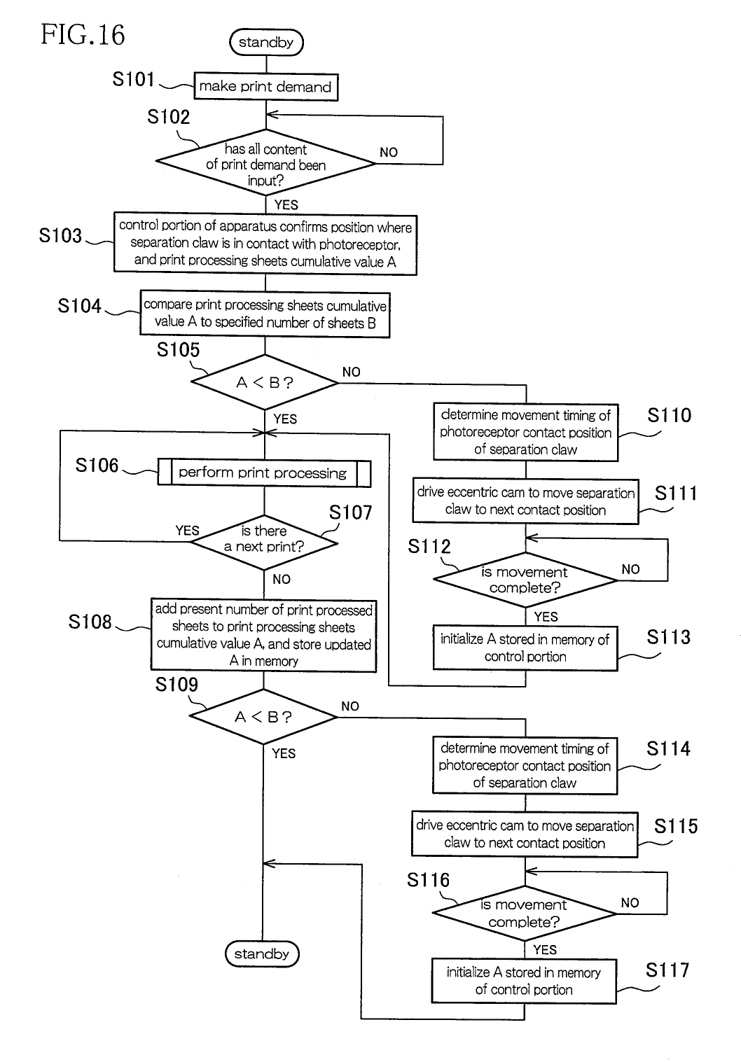

Next is a description of a processing procedure for changing the contact position of each separation claw 61 according to the number of sheets of print processing, with reference to the flowchart in FIG. 16.

First, when a print request is made by operating an operation panel (not shown) of the image forming apparatus 100 (Step S101), notification of the print request is given to the control portion 69. When the print request is received, the control portion 69 waits until all print conditions such as print magnification, number of copies in the print request, and print density have been input (‘No’ in Step S102), and when all of the print conditions have been input (‘Yes’ in Step S102), the control portion 69 confirms that any of the circumferential face positions P1, P2, and P3 of the eccentric cam 66 is in contact with the right end of the support shaft 63, i.e. confirms the position where the separation claws 61 contact the surface of the photosensitive drum 21, then reads out and confirms a print processing sheets cumulative value A from a memory 69a (Step S103).

Confirmation of the circumferential position of the eccentric cam 66 that is in contact with the right end of the support shaft 63 may be performed by detecting the angle of rotation of the eccentric cam 66. The angle of rotation of the eccentric cam 66 can be detected by detecting and controlling the angle of rotation of a motor of the rotational drive source 68. Also, the print processing sheets cumulative value A is added to until reaching a specified number of sheets B described below, and then reset to 0 when reaching the specified number of sheets B.

Next, the control portion 69 compares the print processing sheets cumulative value A read out from the memory 69a to the specified number of sheets B (Step S104), and determines whether or not the print processing sheets cumulative value A is less than the specified number of sheets B, i.e. whether or not the print processing sheets cumulative value A has reached the specified number of sheets B (Step S105).

For example, if the print processing sheets cumulative value A is less than the specified number of sheets B (‘Yes’ in Step S105), i.e. if the print processing sheets cumulative value A has not reached the specified number of sheets B, then the control portion 69 executes print processing according to the print conditions and the print request in Steps S101 and S102 (Step S106), thus printing an image on at least one sheet of recording paper. Then, the control portion 69 confirms whether or not all of the requested print processing has ended (Step S107), and if all of the requested print processing has not ended (‘Yes’ in Step S107), the print processing in Step S106 is continued.

If all of the requested print processing has ended (‘No’ in Step S107), the control portion 69 obtains the number of print processing sheets for which print processing has been performed in Step S106, this number of print processing sheets is added to the print processing sheets cumulative value A, the print processing sheets cumulative value A is updated, and the print processing sheets cumulative value A in the memory 69a also is overwritten and updated (Step S108).

Afterward, the control portion 69 determines whether or not the updated print processing sheets cumulative value A is less than the specified number of sheets B, i.e. whether or not the updated print processing sheets cumulative value A has reached the specified number of sheets B (Step S109).

If the print processing sheets cumulative value A is less than the specified number of sheets B (‘Yes’ in Step S109), i.e. if the print processing sheets cumulative value A has not reached the specified number of sheets B, then the control portion 69 puts the image forming apparatus 100 in a standby state, and when there is a subsequent, new print request, the processing from Step S101 is repeated.

On the other hand, when, before executing the print processing of Step S106, the control portion 69 determines that the print processing sheets cumulative value A has reached the specified number of sheets B (‘No’ in Step S105), this is deemed to be the timing for changing the position where the separation claws 61 contact the surface of the photosensitive drum 21 (Step S110), driving of the rotational drive source 68 is controlled to rotate the eccentric cam 66, and thus the position where the separation claws 61 contact the surface of the photosensitive drum 21 is changed (Step S111). At this time, if the separation claws 61 were at the furthest rightward position P11, they move to the slightly leftward position P12, and if the separation claws 61 were at the slightly leftward position P12, they move to the furthest leftward position P13, and if the separation claws 61 were at the furthest leftward position P13, they move to the furthest rightward position P11. Accordingly, the separation claws 61 move cyclically in order to each position P11, P12, and P13.

When the contact position of the separation claws 61 is changed (‘Yes’ in Step S112) the control portion 69 performs initialization by resetting the print processing sheets cumulative value A to 0 in the memory 69a (Step S113). Then the procedure moves to Step S106 and print processing is executed.

When, after the print processing of Step S106 has been executed, and the print processing sheets cumulative value A has been updated, it is determined that the print processing sheets cumulative value A has reached the specified number of sheets B (‘No’ in Step S109), this too is deemed to be the timing for changing the contact position of the separation claws 61 (Step S114), driving of the rotational drive source 68 is controlled to rotate the eccentric cam 66, and thus the contact position of the separation claws 61 is changed (Step S115). At this time as well, the separation claws 61 are moved from position P11 to position P12, from position P12 to position P13, or from position P13 to position P11. Then, when the contact position of the separation claws 61 is changed (‘Yes’ in Step S116) the control portion 69 performs initialization by resetting the print processing sheets cumulative value A to 0 in the memory 69a (Step S117). Then, the standby state is entered.

In this manner, before and after print processing, a determination is made of whether or not the print processing sheets cumulative value A has reached the specified number of sheets B, and if the specified number of sheets B has been reached, the contact position of the separation claws 61 is immediately changed, so it is possible to change the contact position of the separation claws 61 without a great difference from the timing at which the print processing sheets cumulative value A reached the specified number of sheets B.

Here, when considering the depth of damage to the surface layer of the photosensitive drum 21 due to contact by the separation claws 61, it is preferable to adopt a configuration in which the separation claws 61 make a circuit of the positions P11, P12, and P13 every 5,000 to 10,000 sheets. Therefore, it is good to set the specified number of sheets B to 2,000 to 5,000 sheets, and thus whenever the print processing sheets cumulative value A reaches 2,000 to 5,000 sheets, the contact position of the separation claws 61 will be consecutively changed, and whenever the total number of print processed sheets increases to 5,000 to 10,000 sheets, the separation claws 61 will make a circuit of the positions P11, P12, and P13. As a result, at any of the positions P11, P12, and P13 of the photosensitive drum 21, the time interval that a separation claw 61 contacts the surface of the photosensitive drum 21 will be short, so damage to the surface of the photosensitive drum 21 due to contact by the separation claw 61 will be shallow. Thus, it is possible to suppress the amount of scraping of the photoconductive layer of the photosensitive drum 21 by the cleaning blade 26A in order to uniformly smooth the entire surface of the photosensitive drum 21, and it is possible to prevent beforehand the occurrence of cracks or the like in the photoconductive layer, so print quality can be maintained at a high level.

When a separation claw continually contacts a specific position of the photosensitive drum 21, damage is deeply formed at the specific position of the photosensitive drum 21. When this deep damage is abruptly scraped away, cracks or the like in the photoconductive layer of the photosensitive drum 21 easily occur, markedly harming print quality.

In the present embodiment, the separation claws 61 move cyclically in order to each position P11, P12, and P13, so the damage at each position is shallow, and while the separation claws 61 are making a circuit of the positions P11, P12, and P13, it is possible to uniformly smooth the entire surface of the photosensitive drum 21 by only slightly scraping the photoconductive layer of the photosensitive drum 21 with the cleaning blade 26A.

The present invention is not limited to the above embodiments; various modifications are possible. For example, the ranges in which the resilience coefficient X, Young's modulus Y, and rubber hardness Z of the cleaning blade are set are obtained after prescribing the diameter of the photosensitive drum 21, the contact pressure of the cleaning blade, processing speed, and the like, so when these prescribed values have been changed, the resilience coefficient X, Young's modulus Y, and rubber hardness Z of the cleaning blade should also be changed. In other words, a configuration may be adopted in which the resilience coefficient X of the cleaning blade is lower than for a conventional cleaning blade, the Young's modulus Y of the cleaning blade is higher than for a conventional cleaning blade, and the rubber hardness Z of the cleaning blade is higher than for a conventional cleaning blade, so that the leading edge of the cleaning blade is always in sliding contact with the surface of the photosensitive drum, and damage formed on the surface of the photoreceptor is smoothed by the leading edge of the cleaning blade.

The present invention is applicable not only to an organic photoreceptor, but also to a photoreceptor of amorphous silicon or the like.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus that develops an electrostatic latent image on the surface of a photoreceptor, thus forms a visible image on the surface of the photoreceptor, transfers the visible image from the surface of the photoreceptor to a sheet of recording paper, separates the sheet of recording paper from the surface of the photoreceptor with a separation claw, and cleans the surface of the photoreceptor with a cleaning blade,
wherein the cleaning blade is in sliding contact with the surface of the photoreceptor, and smoothes damage that has been formed on the surface of the photoreceptor by contact of the separation claw.

2. The image forming apparatus according to claim 1, wherein the cleaning blade scrapes away a projecting portion of damage in an uneven shape formed on the surface of the photoreceptor.

3. The image forming apparatus according to claim 1, wherein the cleaning blade is made of rubber member.

4. The image forming apparatus according to claim 1, wherein the sliding contact of the cleaning blade to the surface of the photoreceptor is performed continually without interruption.

5. The image forming apparatus according to claim 1, wherein where the resilience coefficient of the cleaning blade is X, the resilience coefficient X is set in a range of 25<X<35.

6. The image forming apparatus according to claim 1, wherein where the Young's modulus of the cleaning blade is Y, the Young's modulus Y is set to not less than 800 gf/mm².

7. The image forming apparatus according to claim 1, wherein where the harness of the cleaning blade is Z, the hardness Z is set in a range of 70°<Z<80°.

8. The image forming apparatus according to claim 1, wherein a processing speed of the image forming apparatus is not less than 500 mm/sec.

9. The image forming apparatus according to claim 1, wherein the photoreceptor is an organic photoreceptor.

10. The image forming apparatus according to claim 1, wherein by moving the separation claw relative to the surface of the photoreceptor in a direction perpendicular to the movement direction of the surface of the photoreceptor, it is possible to change the position where the separation claw contacts the surface of the photoreceptor, and
the position where the separation claw contacts the surface of the photoreceptor is changed according to the number of sheets of recording paper processed performed by the image forming apparatus.

11. The image forming apparatus according to claim 10, wherein the separation claw is sequentially moved so as to contact any of a plurality of positions where contact is made with the surface of the photoreceptor, and
while the separation claw makes at least one circuit of each of the contact positions, the cleaning blade smoothes damage formed by the separation claw on the surface of the photoreceptor at each of the contact positions.
